(19) United States
(12) Patent Application Publication
(10) Pub. No.: US 2021/0185882 A1
(43) Pub. Date: Jun. 24, 2021

(54) Use Of Aerial Imagery For Vehicle Path Guidance And Associated Devices, Systems, And Methods

(71) Applicant: Ag Leader Technology, Ames, IA (US)

(72) Inventor: Scott Eichhorn, Ames, IA (US)

(21) Appl. No.: 17/132,152

(22) Filed: Dec. 23, 2020

Related U.S. Application Data
(60) Provisional application No. 62/952,807, filed on Dec. 23, 2019.

(51) Int. Cl. A01B 69/00; G05D 1/00; G06K 9/00; G06T 5/00; B64C 39/02

(52) U.S. Cl. CPC A01B 69/004; A01B 69/001; G05D 1/0038; G06K 9/0063; B64C 2201/127; B64C 39/024; G05D 2201/0201; G06T 2207/30181; G06T 5/006

(57) ABSTRACT

The disclosure is related to an aerial guidance system, comprising an imaging device and a processor. In some implementations, the processor is configured to process acquired images, and generate guidance paths. In some implementations the imaging device is a satellite, and the acquired images are stored on a centralized platform.

### CROSS-REFERENCE TO RELATED APPLICATION(S)

This application claims the benefit under 35 U.S.C. § 119(e) to U.S. Provisional Application 62/952,807, filed Dec. 23, 2019, and entitled “Use of Aerial Imagery for Vehicle Path Guidance and Associated Devices, Systems, and Methods,” which is hereby incorporated herein by reference in its entirety for all purposes.

### TECHNICAL FIELD

The disclosure relates generally to devices, systems, and methods for use of aerial imagery for vehicle guidance for use with agricultural equipment navigation. More particularly this disclosure relates to devices, systems, and methods for use of aerial imagery to establish agricultural vehicle guidance paths. This disclosure has implications across many agricultural and other applications.

### BACKGROUND

As is appreciated, during agricultural operations planters and/or other implements do not always follow the planned vehicle guidance paths. For example, a planting implement may not accurately follow a planned guidance path such that crop rows are planted at a variable offset from the planned guidance path. In these situations, the planned guidance path generated for planting cannot be reused during subsequent operations, such as spraying and harvest.

Various vehicle guidance systems are known in the art and include vehicle-mounted visual row following systems. These known mounted vision systems are known to be affected by wind, sections of missing crops, uncertainty about counting rows, and downed plants, among other things. Further these known mounted vision systems often have difficulty identifying crop rows once the plant foliage has grown to the point where bare ground is nearly or wholly obscured.

Alternative known vehicle guidance systems use mechanical feelers. These known mechanical feeler systems are affected by downed corn, mechanical wear, and speed of field operations. Further these known mechanical feeler systems require specialized equipment to be mounted on the tractor or other agricultural vehicle for operation.

There is a need in the art for devices, systems, and methods for establishing vehicle guidance paths for agricultural operations.

### BRIEF SUMMARY

Disclosed herein are various devices, systems, and methods for use of aerial imagery for establishing, transmitting and/or storing agricultural vehicle guidance paths.

In Example 1, an aerial guidance system, comprising an imaging device constructed and arranged to generate aerial images of a field, and a processor in operative communication with the imaging device, wherein the processor is configured to process the aerial images and generate guidance paths for traversal by agricultural implements.

Example 2 relates to the aerial guidance system of Example 1, further comprising a central storage device in operative communication with the processor.

Example 3 relates to the aerial guidance system of Example 1, wherein the imaging device is a satellite.

Example 4 relates to the aerial guidance system of Example 1, wherein the imaging device is a drone.

Example 5 relates to the aerial guidance system of Example 1, further comprising a monitor in operative communication with the processor and configured to display the aerial images to a user.

In Example 6, a method of generating guidance paths for agricultural processes, comprising acquiring overhead images via an imaging device, identifying crop rows in the acquired aerial images, and generating one or more guidance paths for traversal by an agricultural implement.

Example 7 relates to the method of Example 6, further comprising displaying the guidance paths on a monitor.

Example 8 relates to the method of Example 6, further comprising adjusting manually the guidance paths by a user.

Example 9 relates to the method of Example 6, further comprising determining an actual location of one or more geo-referenced ground control points and adjusting the one or more guidance paths based on the actual location of one or more geo-referenced ground control points in the aerial images.

Example 10 relates to the method of Example 6, wherein the imaging device is a terrestrial vehicle, manned aerial vehicle, satellite, or unmanned aerial vehicle.

Example 11 relates to the method of Example 10, wherein the imaging device is an unmanned aerial vehicle.

Example 12 relates to the method of Example 6, further comprising displaying the one or more guidance paths on a display or monitor.

Example 13 relates to the method of Example 6, further comprising providing a software platform for viewing the one or more guidance paths.

In Example 14, a method for providing navigation guidance paths for agricultural operations comprising obtaining aerial images of an area of interest, processing the aerial images to determine actual locations of one or more crop rows, and generating guidance paths based on actual locations of the one or more crop rows.

Example 15 relates to the method of Example 14, further comprising performing distortion correction on the aerial images.

Example 16 relates to the method of Example 14, further comprising identifying actual locations of one or more geo-referenced ground control points found in the aerial images.

Example 17 relates to the method of Example 16, wherein the one or more geo-referenced ground control points comprise at least one of a terrain feature, a road intersection, or a building.

Example 18 relates to the method of Example 14, wherein the aerial images are obtained in an early stage of a growing season.

Example 19 relates to the method of Example 14, further comprising inputting terrain slope data to determine actual crop row locations and spacing.

Example 20 relates to the method of Example 14, further comprising performing resolution optimization on the aerial images.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is an exemplary depiction of a field with a guidance path, according to one implementation.

FIG. 2A is a process diagram of an overview of the system, according to one implementation.

FIG. 2B is a schematic overview of certain components of the system, according to one implementation.

FIG. 2C is a schematic overview of certain components of the system, according to one implementation.

FIG. 3 is a schematic depiction of the system, according to one implementation.

FIG. 4 is an exemplary aerial image, according to one implementation.

FIG. 5 is an exemplary low resolution aerial image, according to one implementation.

FIG. 6 is a schematic diagram of the system including a cross sectional view of a field, according to one implementation.

FIG. 7A shows an exemplary guidance path for a six-row implement, according to one implementation.

FIG. 7B shows exemplary guidance paths for a two-row implement, according to one implementation.

FIG. 8 shows an exemplary guidance path navigating about an obstacle, according to one implementation.

FIG. 9 shows a display for use with the system, according to one implementation.

### DETAILED DESCRIPTION

The various implementations disclosed or contemplated herein relate to devices, systems, and methods for the use of aerial or overhead imagery to establish vehicle guidance paths for use by a variety of agricultural vehicles. In certain implementations, these vehicle guidance paths may be used in agricultural applications, such as planting, harvesting, spraying, tilling, and other operations as would be appreciated. The disclosed ariel system represents a technological improvement in that it establishes optimal guidance paths for agricultural vehicles for traversing a field and/or performing desired operations when previous guidance paths, such as planting guidance paths cannot be used. In certain implementations the aerial system establishes guidance paths via a software-integrated display platform such as SteerCommand® or other platform that would be known and appreciated by those of skill in the art.

Certain of the disclosed implementations of the imagery and guidance systems, devices, and methods can be used in conjunction with any of the devices, systems, or methods taught or otherwise disclosed in U.S. application Ser. No. 16/121,065, filed Sep. 1, 2018, and entitled “Planter Down Pressure and Uplift Devices, Systems, and Associated Methods,” U.S. Pat. No. 10,743,460, filed Oct. 3, 2018, and entitled “Controlled Air Pulse Metering Apparatus for an Agricultural Planter and Related Systems and Methods,” U.S. application Ser. No. 16/272,590, filed Feb. 11, 2019, and entitled “Seed Spacing Device for an Agricultural Planter and Related Systems and Methods,” U.S. application Ser. No. 16/142,522, filed Sep. 26, 2018, and entitled “Planter Downforce and Uplift Monitoring and Control Feedback Devices, Systems and Associated Methods,” U.S. application Ser. No. 16/280,572, filed Feb. 20, 2019 and entitled “Apparatus, Systems and Methods for Applying Fluid,” U.S. application Ser. No. 16/371,815, filed Apr. 1, 2019, and entitled “Devices, Systems, and Methods for Seed Trench Protection,” U.S. application Ser. No. 16/523,343, filed Jul. 26, 2019, and entitled “Closing Wheel Downforce Adjustment Devices, Systems, and Methods,” U.S. application Ser. No. 16/670,692, filed Oct. 31, 2019, and entitled “Soil Sensing Control Devices, Systems, and Associated Methods,” U.S. application Ser. No. 16/684,877, filed Nov. 15, 2019, and entitled “On-The-Go Organic Matter Sensor and Associated Systems and Methods,” U.S. application Ser. No. 16/752,989, filed Jan. 27, 2020, and entitled “Dual Seed Meter and Related Systems and Methods,” U.S. application Ser. No. 16/891,812, filed Jun. 3, 2020, and entitled “Apparatus, Systems, and Methods for Row Cleaner Depth Adjustment On-The-Go,” U.S. application Ser. No. 16/921,828, filed Jul. 6, 2020, and entitled “Apparatus, Systems and Methods for Automatic Steering Guidance and Visualization of Guidance Paths,” U.S. application Ser. No. 16/939,785, filed Jul. 27, 2020, and entitled “Apparatus, Systems and Methods for Automated Navigation of Agricultural Equipment,” U.S. application Ser. No. 16/997,361, filed Aug. 19, 2020, and entitled “Apparatus, Systems, and Methods for Steerable Toolbars,” U.S. application Ser. No. 16/997,040, filed Aug. 19, 2020, and entitled “Adjustable Seed Meter and Related Systems and Methods,” U.S. application Ser. No. 17/011,737, filed Aug. 3, 2020, and entitled “Planter Row Unit and Associated Systems and Methods,” U.S. application Ser. No. 17/060,844, filed Oct. 1, 2020, and entitled “Agricultural Vacuum and Electrical Generator Devices, Systems, and Methods,” U.S. application Ser. No. 17/105,437, filed Nov. 25, 2020, and entitled “Devices, Systems And Methods For Seed Trench Monitoring And Closing,” and U.S. application Ser. No. 17/127,812, filed Dec. 18, 2020, and entitled “Seed Meter Controller and Associated Devices, Systems, and Methods,” each of which is incorporated herein.

Returning to the present disclosure, the various systems, devices and methods described herein relate to technologies for the generation of guidance paths for use in various agricultural applications and may be referred to herein as a guidance system 100, though the various methods and devices and other technical improvements disclosed herein are also of course contemplated.

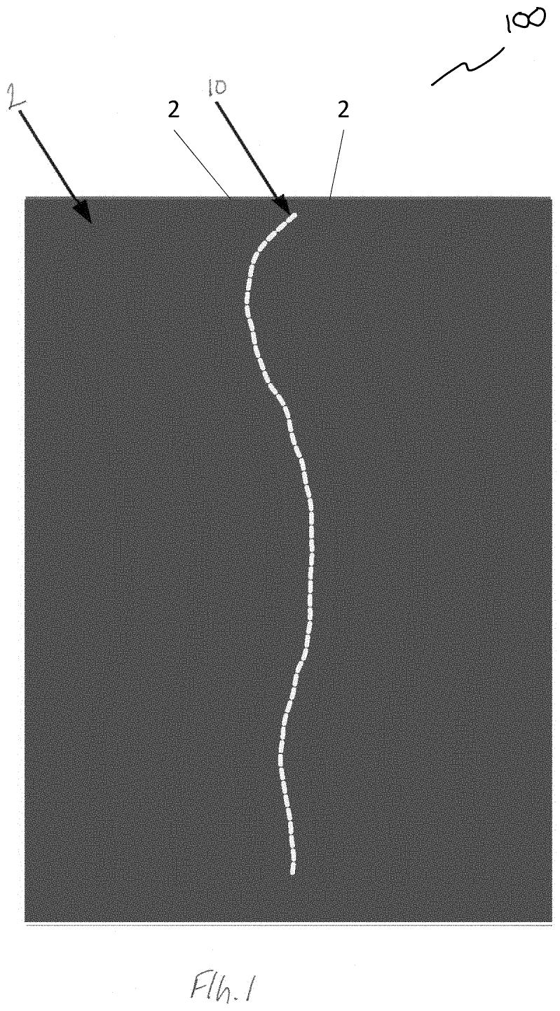

The disclosed guidance system 100 can generally be utilized to generate paths 10 for use by agricultural vehicles as the vehicle traverses a field or fields. For illustration, FIG. 1 shows an exemplary guidance path 10 between crop rows 2. It is understood that as discussed herein, a guidance path 10 can relate to the route to be taken by the center of an agricultural implement so as to plot a path 10 through a field or elsewhere to conduct an agricultural operation, as would be readily appreciated by those familiar with the art.

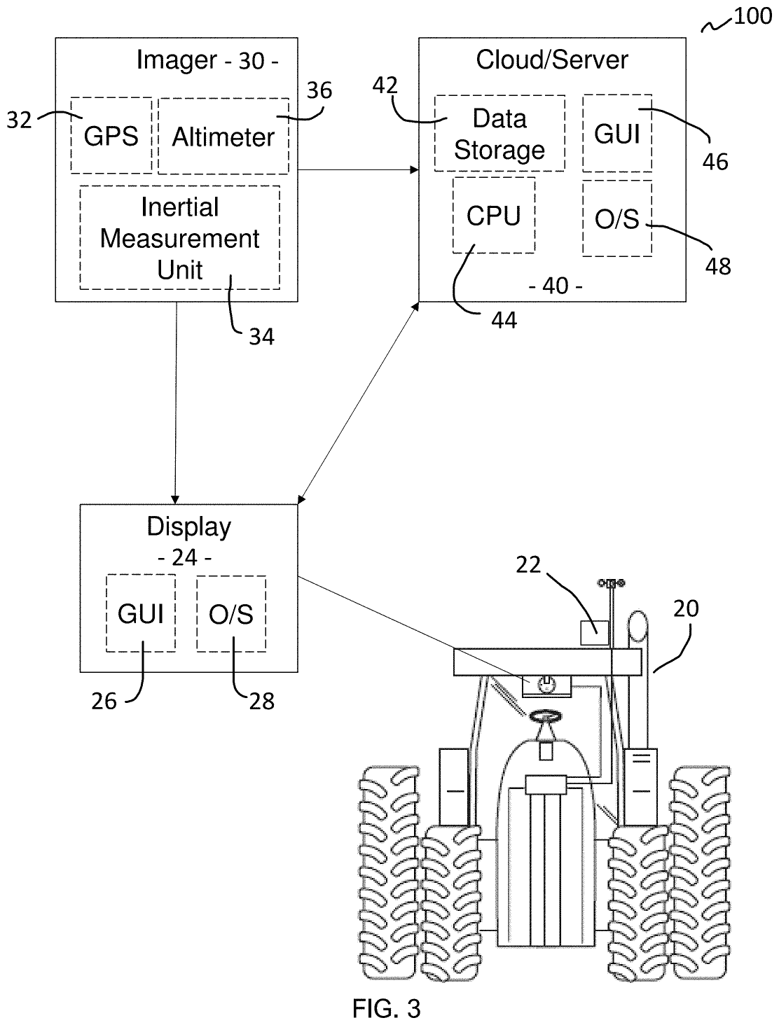

In these implementations, the vehicle guidance paths 10 may include heading and position information, such as GPS coordinates indicating the location(s) where the tractor and/or other vehicle should be driven for proper placement within a field, such as between the crop rows 2, as has been previously described in the incorporated references. It would be appreciated that various agricultural vehicles include a GPS unit (shown for example at 22 in FIG. 3) for determining the position of the vehicle within a field at any given time. This GPS unit may work in conjunction with the system 100, and optionally an automatic steering system, to negotiate the tractor or other vehicle along the guidance paths 10, as would be appreciated.

As would be understood, the guidance paths 10 are used for agricultural operations including planting, spraying, and harvesting, among others. In various known planting or other agricultural systems, as discussed in many of the references incorporated herein, vehicle guidance paths 10 are plotted in advance of operations to set forth the most efficient, cost effective, and/or yield maximizing route for the tractor or other vehicle to take through the field. Additionally, or alternatively, the generated guidance paths 10 may be used for on-the-go determinations of vehicle paths and navigation.

The various guidance system 100 implementations disclosed and contemplated herein may not be affected by wind, sections of missing crops, uncertainty about counting rows, and/or downed crops, as experienced by prior known systems. In certain implementations, the aerial imagery is gathered prior to full canopy growth such that the visual obstruction of the ground at later stages of plant growth will not affect the establishment of vehicle guidance paths. In alternative implementations, the aerial imagery may be gathered at any time during a growing cycle.

In certain implementations, the system 100 includes geo-reference ground control points. Geo-referenced ground control points may include various static objects with known positions (known GPS coordinates, for example). In another example geo-referenced ground control points may include temporary, semi-permanent, or permanent reference targets placed in and/or around an area of interest. The positions of these geo-referenced ground control points are known and may then be integrated into the aerial imagery to create geo-referenced imagery with high accuracy, as will be discussed further below.

It is appreciated that in many instances a guidance system for a planter generates planned guidance paths for use during planting operations, as is discussed in various of the incorporated references. In one example, as noted above, during planting operations the planter and/or associated implement(s) often do not accurately follow the planned guidance paths during planting, thereby planting crop rows 2 at a variable offset from the prior planned planting guidance paths. Deviation from the planned guidance paths may be caused by of variety of factors including GPS drift, uneven terrain, unforeseen obstacles, or other factors as would be appreciated by those of skill in the art. The various implementations disclosed herein allow for setting subsequent vehicle guidance paths 2 that correspond to the actual crop rows 2 rather than estimates of crop row 2 locations derived from the prior planned planting guidance paths that may no longer give an accurate depiction of the location of crop rows 2 within a field.

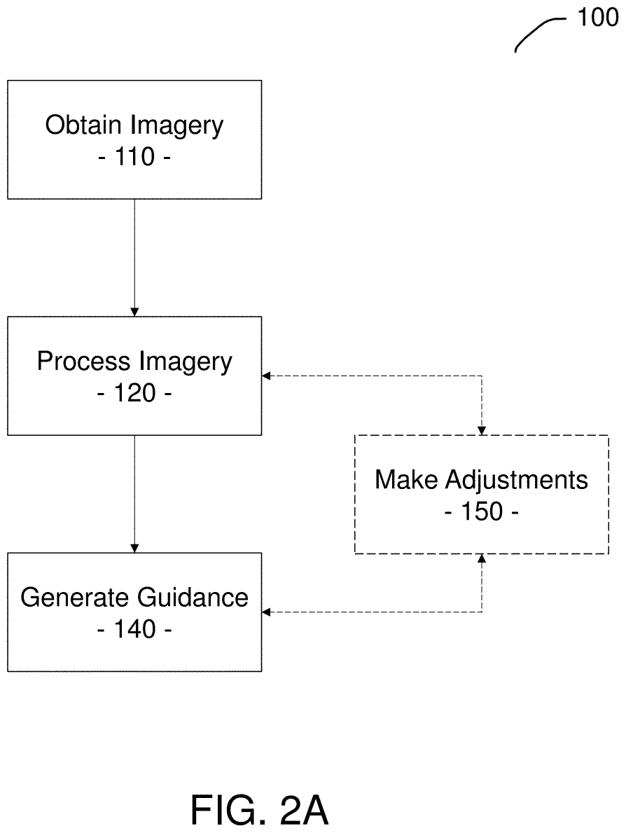

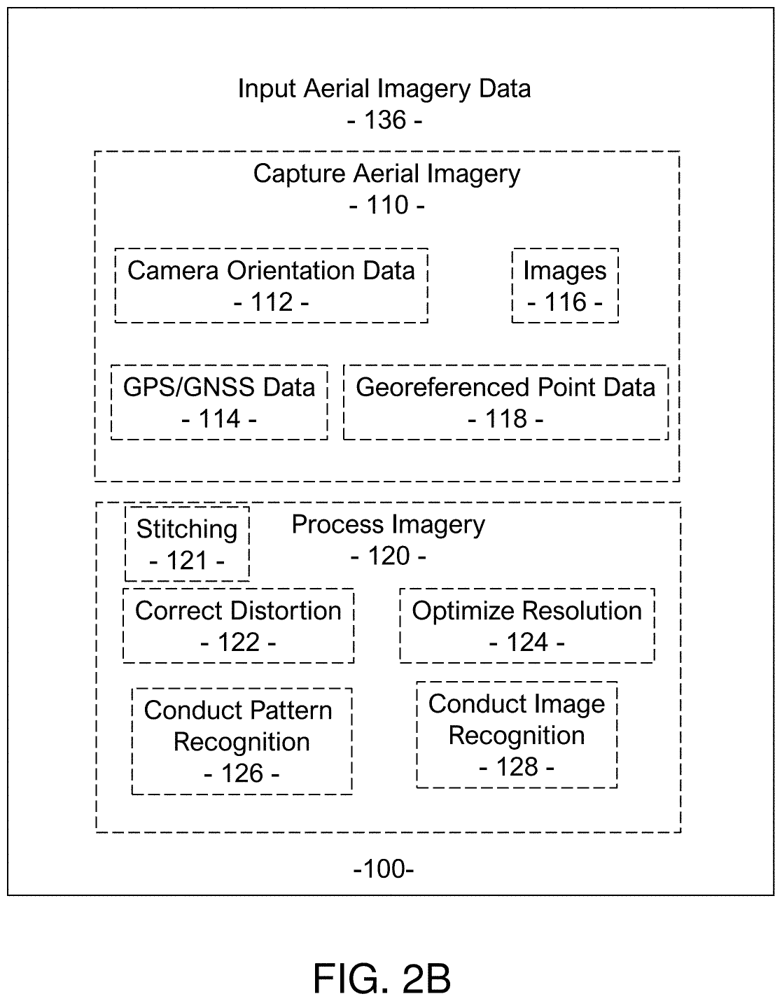

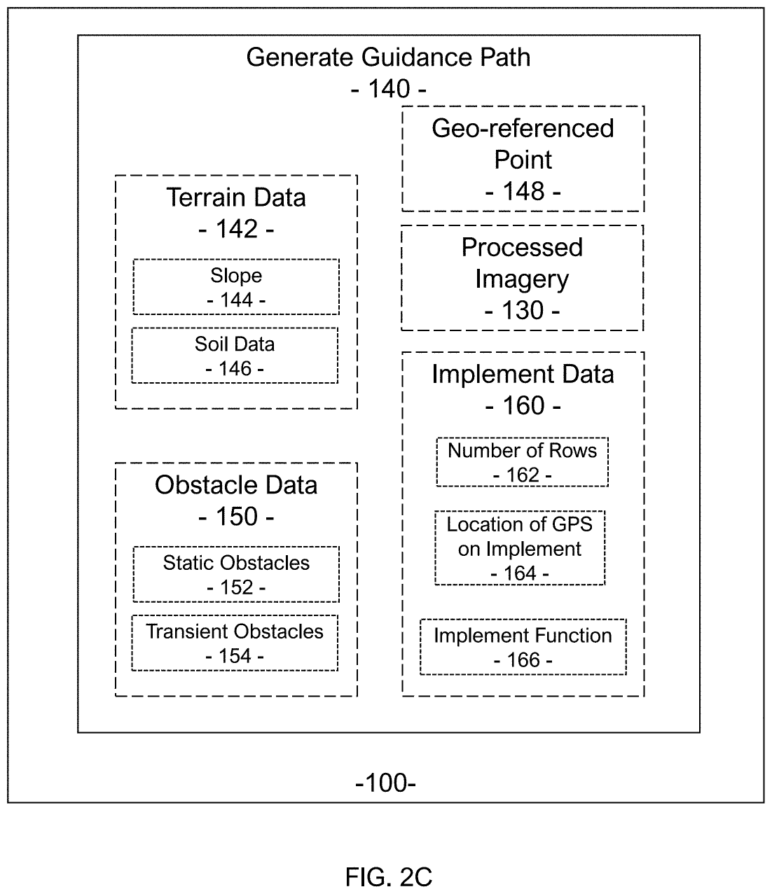

FIGS. 2A-C depict exemplary implementations of the guidance system 100. The system 100 according to these implementations includes one or more optional steps and / or sub-steps that can be performed in any order or not at all. In one optional step, the system 100 obtains imagery (box 110), such as from a satellite, unmanned aerial vehicle, and/or other high altitude imaging device or devices. In a further optional step, the system 100 processes the imagery (box 120), such as by performing stitching, distortion correction, resolution optimization, image recognition and/or pattern recognition, each of which will be detailed further below. In another optional step, the system 100 generates guidance paths (box 140) using the imagery data and various other inputs and operating parameters as would be appreciated. In a still further optional step, the system 100 allows for various adjustments to the imagery, data, and/or generated guidance paths to be made (box 150). Each of these optional steps and the sub-steps and components thereof will be discussed further below.

### Imagery Acquisition

In various implementations, the system 100 obtains or receives aerial or other overhead imagery (box 110) of the area of interest. As shown in FIG. 3, the aerial imagery may be obtained via one or more imagers 30. The imager 30 may be one or more of a satellite, an unmanned aerial vehicle (also referred to herein as a “drone” or “UAV”), a manned aerial vehicle (such as a plane), one or more cameras mounted to an terrestrial or ground based vehicle, or any other device or system capable of capturing and recording aerial or overhead imagery as would be appreciated by those of skill in the art.

Turning back to FIG. 2B, in some implementations, the aerial imagery is captured (box 110) before the crop canopy obstructs the view of the ground, thereby obscuring visual identification of the crop rows (shown for example at 2 in FIG. 1) via the contrast between the plant matter and the soil. In alternative implementations, the aerial imagery is captured (box 110) at any other time in the growing cycle and various alternative image processing techniques may be implemented to identify the location of crop rows 2, some of which will be further described below. As would be appreciated with high resolution imagery, a processing system may identify individual crop rows 2 even from a fully grown canopy.

For use in navigational path planning, the images used to identify crop rows 2 and plot guidance paths 10 may have a high degree of absolute or global positional accuracy. In practice, the latitude and longitude or other positional coordinates of each pixel, or subset of pixels, in the image may be known or otherwise approximated with a high degree of accuracy.

As shown in FIG. 2B, when capturing aerial imagery (box 110) the system 100 may additionally capture and record various data including but not limited to camera orientation data (box 112), global positioning system (GPS)/global navigation satellite system (GNSS) data (box 114), images (box 116), and geo-referenced point data (box 118). In various implementations, the imager, shown in FIG. 3, may include a variety of sensors such as a GPS sensor 32, an inertial measurement unit 34, altimeter 36, or other sensor(s) as would be appreciated by those of skill in the art, for the collection and recording of various data.

As shown in FIGS. 2B and 3, in various implementations, the GPS sensor 32 may record the positional information of the imager 30, such as a drone, during image capture (box 110). The positional information, such as GPS data (box 114), may then be extrapolated and used to generate positional information for the images (box 116). In certain implementations, the GPS sensor 32 is a Real-Time-Kinematic (RTK) corrected GPS configured to provide the required level of absolute accuracy. As would be understood the GPS sensor 32 is at a known position relative to the imager 30/point of capture of the imager 30 configured to capture the aerial imagery (box 110). In these implementations, the known position of the GPS 32 is utilized by the system 100 to geo-reference the images (box 116).

In further implementations, the imager 30 includes an inertial measurement unit 34 to capture data regarding the orientation of the imager 30 during image capture (box 110). In certain implementations, the inertial measurement unit 34 may capture and record data regarding the roll, pitch, and yaw of the imager 30 at specific points that correspond to locations within the images (box 116). This inertial measurement data may be integrated into the captured imagery such as to improve the accuracy of the positional information within the images (box 116). That is, the inertial data may allow the system 100 to more accurately place the subject item in three-dimensional space and therefore more accurately plot guidance, as discussed herein.

Continuing with FIGS. 2B and 3, in further implementations, the imager 30 may include an altimeter 36 or other sensor to determine the height of the imager 30 relative to the ground. As with the inertial measurement unit 34 discussed above, data relating to the height/altitude at which the images are acquired by improve the geo-referencing accuracy and as a result the overall accuracy of the system 100 can be improved.

In one specific example, the system 100 may use a senseFly eBee RTK drone as the imager 30 to collect the orientation (box 112), position (box 114), and image (box 116) data followed by data processing using DroneDeploy software, as will be discussed further below. In these and other implementations, images may be captured (box 110) with 1.2 cm image location accuracy.

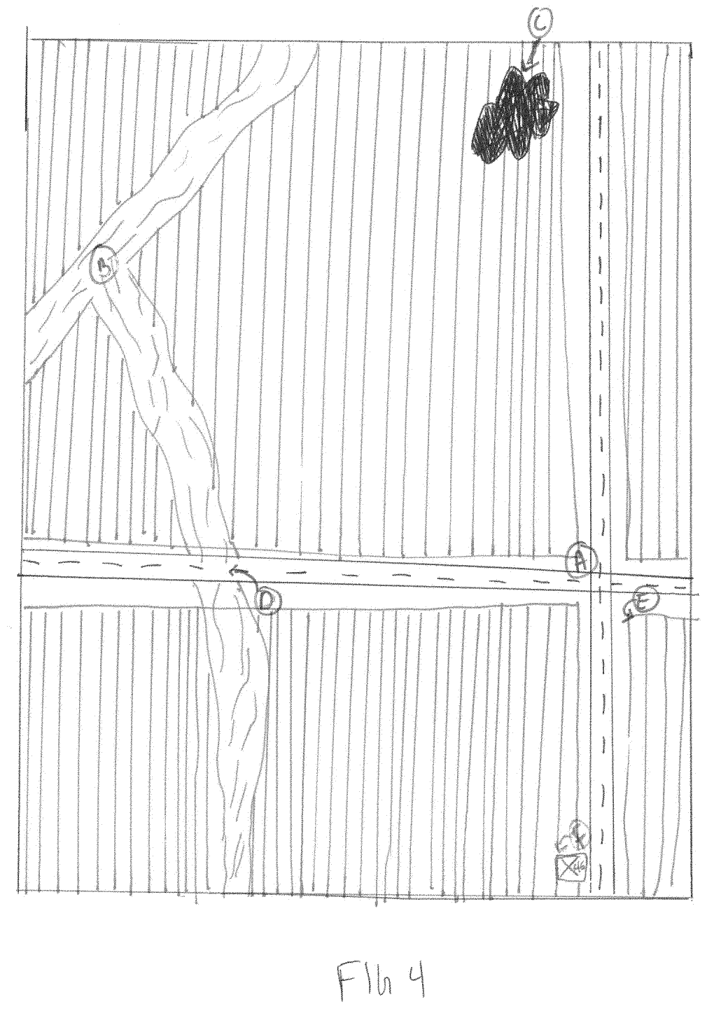

In certain implementations, the aerial imagery optionally includes and/or is super imposed with geo-referenced ground control points (box 118 in FIG. 2B), examples of which are shown in FIG. 4 at A-E. Various exemplary geo-referenced ground control points may include, a road intersection A, a stream intersection B, a rock outcrop C, a bridge D, a corner of a field E, a structure, a feature on a structure, among others as would be appreciated by those of skill in the art. In further implementations, the guidance system 100 may include geo-referenced ground control points specifically placed in or on the ground and/or field, such as a labeled marker F.

In certain implementations, the system 100 records the location of one or more geo-referenced ground control points. In certain implementations, the location is recorded as a set of GPS coordinates. In various implementations, the system 100 utilizes the one or more geo-referenced ground control points to assist in proper alignment of aerial imagery and guidance paths with to a navigation system, as will be discussed further below. As would be understood, certain geo-referenced ground control points will remain the same year over year or season over season such that the data regarding these stable geo-referenced ground control points may be retained by the system 100 to be reused during multiple seasons.

Continuing with FIG. 2B, in certain implementations, uncorrected GPS data (box 114) may be used in conjunction with the geo-referenced ground control points (box 118) to correct image location data and remove much of the absolute error inherent to image capture. In certain implementations, commercially available software, such as DroneDeploy or Pix4D, can be used with one or more geo-referenced ground control points (shown for example in FIG. 4 at A-F) with known GPS coordinates or other absolute position information (box 114 in FIG. 2B) to assign GPS coordinates and/or absolute position information to the corresponding pixels in the imagery. The software may then extrapolate these coordinates out to the other pixels in the image, effectively geo-referencing the entire image to the proper navigational reference frame.

In some implementations, the system 100 may acquire additional data, via the imaging devices or otherwise, such as lidar, radar, ultrasonic, or other data regarding field characteristics. In various of these implementations, the aerial imagery (box 110 of FIG. 2B) and/or other data can be used to create 2D or 3D maps of the fields or other areas of interest.

In still further implementations, the system 100 may record information relating to crop height. For example, crop height can be recorded as part of 3D records. In various implementations, crop height data can be used for plant identification and/or enhancing geo-referencing processes described above.

### Storage

Continuing with FIGS. 2B and 3, in another optional step, the obtained imagery (box 110), data regarding geo-referenced ground control points (box 118), and/or other data is sent from the imager 30 to a storage device 40 such as a cloud-based storage system 40 or other server 40 as would be appreciated. In some implementations, cloud-based system 40 or other server 40 includes a data storage component 42 such as a memory 42, a central processing unit (CPU), a graphical user interface (GUI) 46, and an operating system (O/S) 48. In some implementations, the imagery (box 110) and other data (such as that of boxes 112-118) is stored in the data storage component 42 such as a memory 42 which may include a database or other organizational structure as would be appreciated.

In various implementations, the cloud 40 or server system 40 includes a central processing unit (CPU) 44 for processing (box 120) the imagery (box 110) from storage 42 or otherwise received from the imager 30, various optional processing steps will be further described below. Further, in certain implementations, a GUI 46 and/or O/S 48 are provided such that a user may interact with the various data at this location.

As shown in FIG. 3, in various implementations, a tractor 20 or display 24 associated with a tractor 20 or other vehicle is in electronic communication with the server 40 or cloud 40. In some implementations, the server 40 or data therefrom may be physically transported to the display 24 via hardware-based storage as would be appreciated. In alternative implementations, the server 40/cloud 40 or data therefrom is transported to the display 24 via any appreciated wireless connection, such as via the internet, Bluetooth, cellular signal, or other methods as would be appreciated. In certain implementations, the display 24 is located in or on the tractor 20 and may be optionally removable from the tractor 20 to be transportable between agricultural vehicles 20.

In some implementations, the gathered imagery may be stored on a central server 40 such as a cloud server 40 or other centralized system 40. In some of these implementations, individual users, in some instances across an enterprise, may access the cloud 40 or central server 40 to acquire imagery for a particular field or locations of interest. In some implementations, the image processing, discussed below, occurs on or in connection with the central storage device 40.

### Image Processing

Turning back to FIG. 2B and FIG. 3, in another optional step, the obtained aerial imagery (box 110) is processed via an image processing sub-system (box 120), the image processing sub-system (box 120) includes one or more optional steps that can be performed in any order or not at all, shown in one implementation in FIG. 2B. The image processing sub-system (box 120) is configured to use various inputs, including aerial imagery (box 110), to identify the crop rows 2 (shown for example in FIG. 1). In various implementations, the image processing sub-system (box 120) is executed on a processor 44 within the central server 40, and/or on a display 24 and processing components associated therewith, various alternative computing devices may be implemented as would be appreciated by those of skill in the art.

As shown in FIG. 2B, in some implementations, the image processing sub-system (box 120) includes one or more optional sub-steps including image stitching (box 121), distortion correction (box 122), resolution optimization (box 124), image recognition (box 126), and/or pattern recognition (box 128). These and other optional sub-steps can be performed in any order or not at all. Further, in some implementations, the one or more of the optional sub-steps can be performed more than once or iteratively.

As also shown in FIG. 2B, various image process steps (box 120) may be conducted via known processing software such as Pix4D, DroneDeploy, Adobe Lightroom, Adobe After Effect, PTLens, and other software system known in the art.

Turning to the implementation of FIG. 2B more specifically, in one optional processing (box 120) sub-step, the captured images (shown at FIG. 2A at box 110) may be stitched together (box 121), that is, combining the images having overlapping fields of view and/or various captured details and locations to produce a combined image featuring a combination of the images to comprehensively and accurately image the subject field, as would be understood.

In use according to these implementations, the imager 30, shown in FIG. 3, may acquire multiple images of the same location through multiple passes and/or certain images may contain overlapping areas. As shown in FIG. 2B, in these situations, the images may be stitched together (box 121) to create a cohesive, accurate high-resolution image of the area of interest, without duplication. As would be appreciated, by stitching together images, a higher resolution image may be obtained.

In a further optional sub-step shown in FIG. 2B, various camera and perspective distortions may be corrected (box 122). Distortion correction (box 122) may be implemented to maintain or improve the positional accuracy of the imagery (box 110). In some implementations, fidelity of the positional data (boxes 114, 118) associated with the imagery (box 110) may be improved via various known geo-referencing techniques as would be understood and appreciated by those of skill in the art.

In certain implementations, the distortion correction (box 122) shown in FIG. 2B corrects for various distortions in the images (box 116) such as those caused by various lens types used to obtain the images (box 116) such as fisheye lenses. Various other types of distortions that may be corrected for include optical distortion, barrel distortion, pin cushion distortion, moustache distortion, perspective distortion, distortion caused by the type and shape of lens used, and other types of distortion known to those of skill in the art. These various types of distortion may be corrected via known image processing techniques, as would be appreciated.

In further implementations, and as also shown in FIG. 2B, the imagery may be optionally processed (box 120) and the accuracy of one or more geo-referenced ground control points (shown for example in FIG. 4 at A-F) may be improved by applying additional data inputs such as, but not limited to, data recorded and/or configured during planting. Examples of this data may include the amount of space between planted rows, the recorded position of the tractor during planting, the position of the planting implement itself during planting, the number of rows on the planting implement, and the position in the field where planting was started and/or halted.

Continuing with FIG. 2B, in some implementations, the crop rows 2 (shown for example in FIG. 1) are identified using the aerial imagery (box 110). Using the known actual spacing and number of row units on the planting implement, the system 100 can better find the best fit between the crop rows 2 identified in the imagery.

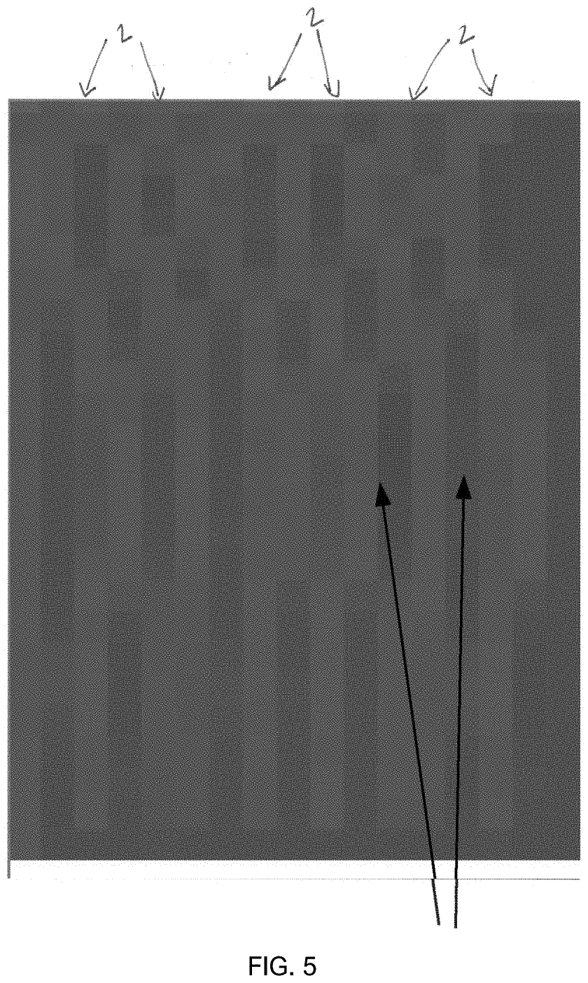

In some implementations, the system 100 and image processing sub-system (box 120) execute the optional step of resolution optimization (box 124), as shown in FIG. 2B. In certain implementations, the captured aerial imagery (box 110) may have insufficient resolution or otherwise lack sufficient clarity to identify crop rows 2. FIG. 5 shows an exemplary image with low resolution and/or low clarity. In implementations where the imagery has inadequate resolution or low clarity, the spacing detected between each row by the system 100 may vary by a few inches or greater, shown in FIG. 5 at X and Y, although the planter row units are at a fixed distance from each other such that there is substantially no actual variation in row spacing.

Turning back to FIG. 2B, in various implementations, the image processing system (box 120) can optimize the imagery via resolution optimization (box 124). Resolution optimization (box 124) may include several optional steps and sub-steps that can be performed in any order or not at all. To optimize the imagery the system 100 may use known data inputs such as the planter row width and number of row units on the planting implement. Use of these known data inputs may allow the system 100 to increase row identification accuracy. Of course, the imagery may be optimized (box 124) via any optimization routine or practice known to those skilled in the art.

Continuing with FIG. 2B, in further implementations, the image processing system (box 120) may perform an optional step of image recognition (box 126) and/or a step of pattern recognition (box 128). As would be appreciated, any wavelength of light that can distinguish between the plants and the ground can be used during image recognition (box 126) to differentiate between those pixels belonging to a plant and those of the ground, respectively.

In certain implementations, additional data such as data from lidar, radar, ultrasound and/or 2D and 3D records can be used instead of or in addition to the imagery (box 110) to recognize and identify the actual locations of crop rows 2. Of course, any other image recognition technique could be used as would be recognized by those of skill in the art, such as those understood and appreciated in the field.

In some implementations, the system 100 uses an optional pattern recognition (box 128) sub-step during image processing (box 120), as shown in FIG. 2B. In various of these implementations, the imagery is used to identify each crop row 2. Various image recognition (box 126) and pattern recognition (box 128) techniques can be implemented including, but not limited to, image segmentation, object bounding, image filtering, image classification, and object tracking. In further implementations, the system 100 may implement machine learning such as via the use of a convolutional neural network, a deterministic model, and/or other methods familiar to those skilled in the art.

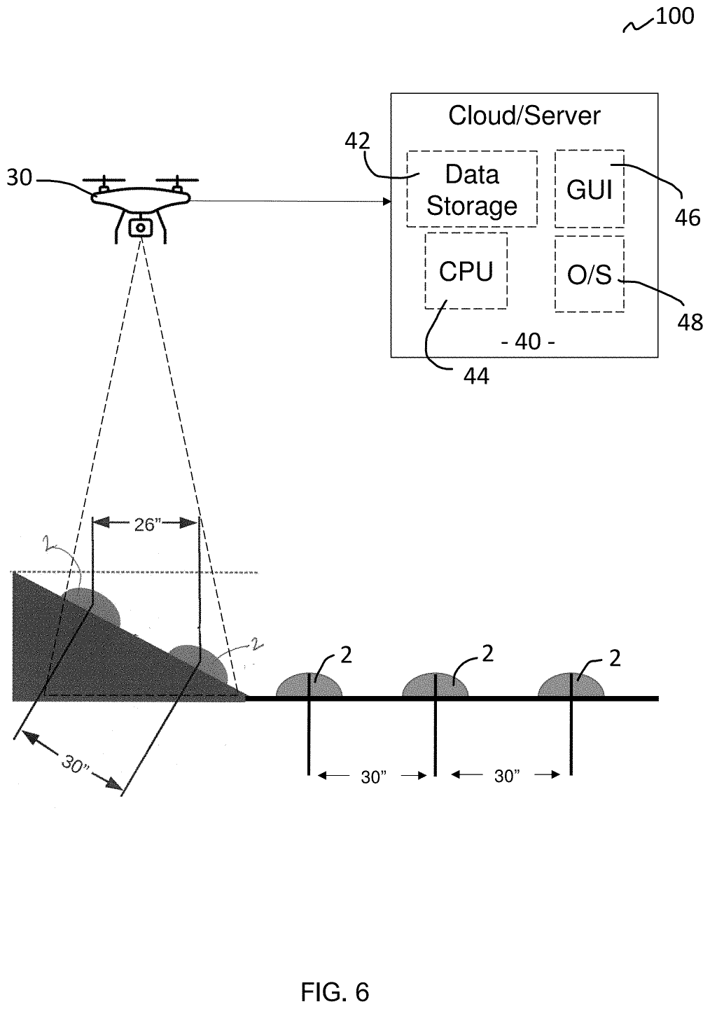

FIG. 6 shows an example where crops 2 are planted on a slope at a fixed width. In such a situation, the crop rows 2 are planted at a fixed width, such as 30 inches, but when images of these rows 2 are captured by an imager 30, the width between the crop rows 2 will appear to be smaller due to the slope. In the example of FIG. 6, the crop rows 2 will appear closer together, 26 inches apart, from overhead rather than the actual distance of 30 inches. In various implementations, the system 100 may use the information regarding crop row 2 spacing to estimate the degree of terrain slope. For example, the imager 30 may collect images of the rows 30 and transmit those images to the cloud 40 or other server 40 where a CPU 44 or other processer processes the images to determine the slope of the ground at a particular location by enforcing the known spacing between rows 2. In further implementations, the crop row 2 spacing and the degree of terrain slope can be combined with other data, such as preexisting survey information, to further enhance accuracy of the geo-referenced imagery (box 110 of FIG. 2B).

### Guidance Generation

In another optional step, the identified crop rows 2 acquired via image acquisition (box 110) and processing (box 120) may be used to plan or generate guidance paths 10 (box 140) for navigation within and around a field, shown in FIG. 2C. As noted above, guidance paths 10 (shown for example in FIG. 1) may be collection of navigational coordinates, such as global positioning system (GPS) coordinates, suitable for use by a vehicle steering guidance system. Vehicle steering guidance systems may rely on inertial navigation equipment, satellite navigation, terrestrial navigation, and/or other navigation equipment, as would be appreciated, and as discussed in various of the references cited herein.

In various implementations, like that shown in FIG. 2C, the system 100 uses a variety of data points in addition to the processed imagery (box 130) to generate guidance paths (box 140). In certain implementations, the system 100 uses terrain data (box 142) such as data regarding slope (box 144) and/or soil data (box 146). In further implementations, the system 100 uses obstacle data (box 152) such that the vehicle 20 may navigate around obstacles as necessary.

Continuing with FIG. 2C, in certain implementations, static obstacles (box 152) are recorded by the system 100. These static obstacles (box 152), such as structures, fences, and/or roads, do not change or are unlikely to change year over year. In these implementations, the location of static obstacles (box 152) may be stored by the system 100 to be used in numerous seasons. In certain implementations, light detection and ranging systems (LIDAR) and/or collision avoidance systems are used to detect such static obstacles (box 152). In further implementations, artificial intelligence and/or machine learning techniques may be utilized to detect and record such static obstacles (box 152). In still further implementations, a user my identify and classify an obstacle as a static obstacle (box 152). In various implementations, the system 100 may recognize changes in the location of a static obstacles (box 152) and/or that a static obstacle (box 152) is missing from the imagery and alert a user. As would be appreciated, various static objects and the positional information thereof may be used as geo-referenced ground control points (shown for example in FIG. 4 at A-F).

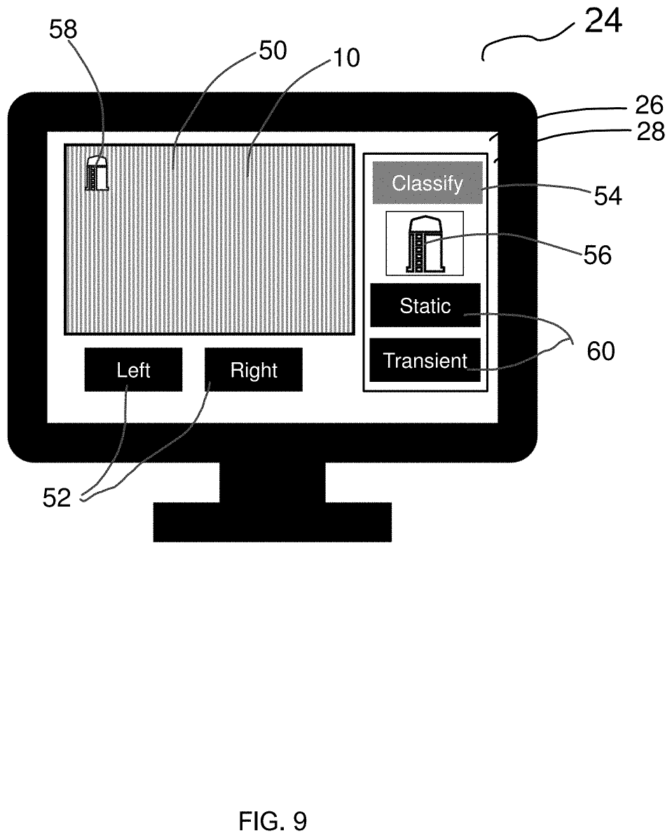

In some implementations shown in FIG. 2C, transient obstacles (box 154) are detected in imagery (box 130) and recorded by the system 100. Certain transient obstacles (box 154) such as humans, animals, or vehicles located in the imagery (box 130) may be ignored by the system 100 when generating guidance (box 140) as such transient obstacles (box 154) are unlikely to remain in the same location for a significant period of time. Various alternative transient obstacles (box 154) may be recorded by the system 100 and used when generating guidance paths (box 140). For example, a flooded zone, a pond, and/or rocks may be located within a field but are more likely to change boundaries or locations over time such that their positional information may remain static for one season but are unlikely to remain in exactly the same position year over year. As noted above, in certain implementations, these transient obstacles (box 154) may be identified by artificial intelligence (AI) or machine learning techniques. Alternatively a user may flag or input various transient obstacles (box 154) via a GUI 26, 46, as shown in FIG. 3 and as will be discussed further below in relation to FIG. 9.

Continuing with the implementation of FIG. 2C, after the crop rows 2 are identified, with or without geo-referenced points, in certain implementations guidance paths 10 may be generated (box 140). As would be appreciated, guidance paths 10 are typically, but not always, placed halfway between adjacent crop rows 2. In certain implementations, as would be appreciated, guidance paths 10 are typically generated such that a display 24 or other steering system on the vehicle 20 may work with the on-board GPS 22 located on the tractor 20 or other vehicle to follow the guidance paths 10. In various implementations, the on-board GPS 22 may be centrally located on the vehicle 20 such that a guidance path 10 central to two crop rows 2 is appropriate. In alternative implementations, the on-board GPS 22 may be offset from the center of the vehicle 20 such that the guidance path 10 may vary similarly from the center point between two crop rows 2. The location of the on-board GPS 22 may vary for different vehicles 20 but would be a known value to be accounted for by the display 24 when generating guidance paths 10.

Further, as shown in FIG. 2C, various implement data (box 160) may be used, such as the number of rows covered (box 162), the location of the on-board GPS (box 164), and/or the implement function (box 166). It is appreciated that various vehicles, machinery, and implements may cover a different number of crop rows 2 with each pass. For example, a planter may cover eighteen (18) rows while a harvester may only cover six (6) rows. Due to the variability in characteristics between agricultural equipment, different types of equipment may require different guidance paths 2.

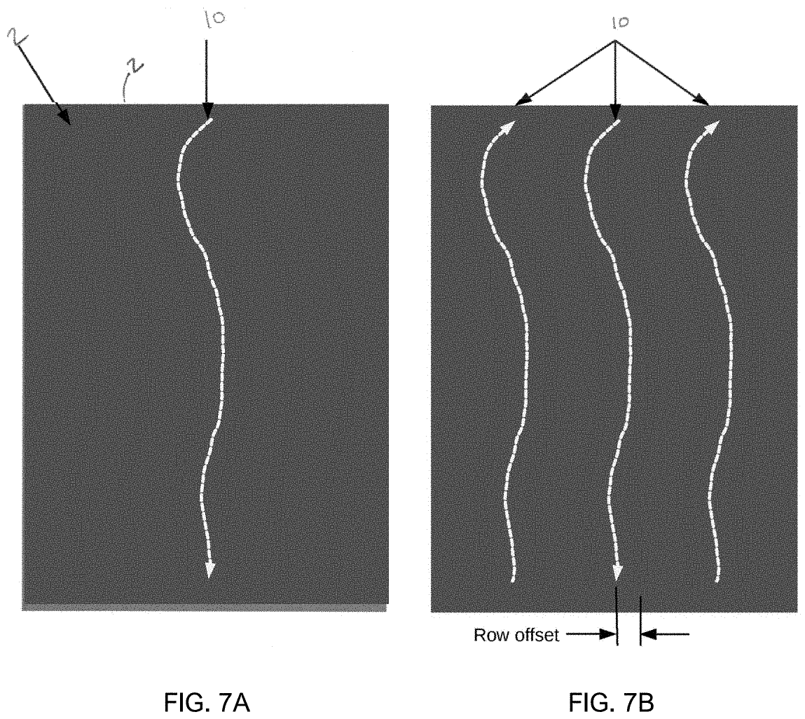

In some implementations, the system 100 may generate guidance (box 140) for one or more different vehicles or implements, as shown in FIGS. 7A and 7B. In various implementations, the system 100 may optimize guidance paths 10 to provide the efficient operations including considering refilling chemicals, refueling, unloading grain, and other peripheral operations as would be appreciated.

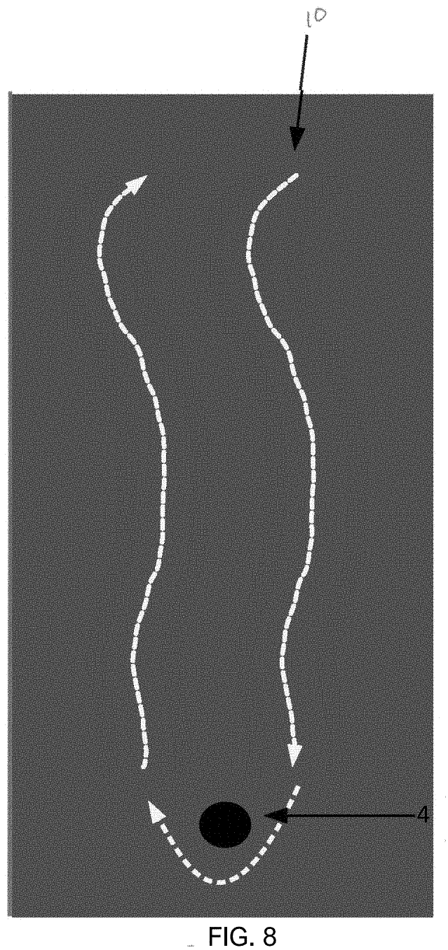

As shown in FIG. 8, in some implementations, the system 100 may use field boundaries and/or obstacle 4 locations when generating guidance (box 140). In these implementations, the guidance paths 10 may be generated (box 140) such as to be between each row as well as avoiding collisions with obstacles 4 and/or negotiating around obstacles 4.

Turning back to FIG. 2C, in further implementations, the system 100 may detect and/or locate terrain features and data (box 142), such as ditches and waterways, that require the vehicle to slow down to prevent vehicle damage and/or user discomfort. The system 100 may identify terrain features via an elevation map, lack of crops shown in the imagery, existing drainage maps, and/or any combination thereof. In various implementations, the generated guidance (box 140) may include instructions regarding vehicle speed, gears, and/or other parameters that may be automatically adjusted to appropriate levels as indicated. Further, in some implementations, the generated guidance (box 140) may include instructions to either apply or turn off the application of herbicides, fertilizer, and/or other chemical and treatments as indicated by the imagery and/or other collected data.

### Geo-Referencing and Adjustments

Returning to FIG. 2A, in some implementations, adjustments (box 150) may be necessary to maintain a high degree of fidelity between the generated guidance (box 140) and the actual vehicle location. In some implementations, the guidance path 10 pattern may be shifted with respect to the current vehicle navigational frame of reference. Adjustments (box 150) may be automatic and/or manual. In some implementations, adjustments (box 150) may eliminate lateral and/or longitudinal bias, such as that created by GPS drift or other phenomena as would be appreciated.

In some implementations, the guidance (box 140) may be adjusted using one or more reference locations (box 148), such as geo-referenced ground control points A-F discussed above in relation to FIG. 4. In these implementations, the vehicle may be driven to a specific reference location and the bias between the actual vehicle location and the recorded location compared, measured, and corrected.

In an alternative implementation, the guidance paths 10 (box 140) may be adjusted by driving the vehicle in the field, gathering data, and using the data to eliminate positional bias. In various implementations, the data gathered may include the navigational track of the vehicle, vehicle speed, and/or data from vehicle mounted sensors such as to detect the presence and/or absence of the planted crops 2. In various implementations, then when the system 100 collects sufficient data to determine the location of the vehicle with a high confidence with respect to the map then automatic guidance and navigation may be engaged.

Turning to FIG. 9, in these and other implementations, the display 24 may show an orthomosaic image 50 of the field derived from the imagery, guidance paths 10 within the field 50, a classification function 54 and/or other information or functions as would be appreciated. In certain implementations, the display 24 may be a monitor or other viewing device as would be appreciated by those of skill in the art. In various implementations, the display 24 may be a touch screen display 24 or other interactive display 24.

In various implementations, an operator may shift the map and/or guidance paths 2 until the guidance paths 10 are properly aligned with crops 2/imagery 50, as shown and discussed in relation to FIG. 2A at box 150. As shown in FIG. 9, a display 24 may be configured with a graphical user interface 26 including one or more buttons 52 to adjust the alignment of the field imagery 50 and the guidance paths 10. For example, a user may manually adjust the guidance paths 10 in relation to the navigational system of the tractor 20 or other agricultural implement by pressing the left, right, or other appropriate buttons 52, as would be understood. In various implementations, this manual adjustment may eliminate lateral bias. Of course alternative implementations and configurations are possible.

It is understood that various implementations make use of an optional software platform or operating system 28 that receives raw or processed acquired images, or one or more guidance paths 10 for use on the display 24. That is, in various implementations, the various processors and components in the user vehicle 20 may receive image and/or guidance data at various stages of processing from, for example, a centralized storage (such as the cloud 40 of FIG. 3), for further processing or implementation in the vehicle 20, such as via a software platform or operating system 28.

Turning back to FIG. 9, in some implementations, longitudinal bias of the guidance paths 10 may be adjusted via monitoring when grain is harvested, such as via a yield monitor or stalk counter, as would be understood. In certain implementations, yield monitoring and/or stalk counting are integrated functions in the display 24. In an alternative implementation, longitudinal bias of the guidance paths 10 may be adjusted via monitoring when herbicide or fertilizer is being applied thereby determining where the crop 2 starts and/or ends.

In further implementations, the display 24 may include a classification function 54 for use with the obstacle data (box 150 in FIG. 2C). Continuing with FIG. 9, in various implementations the classification function 54 may present a user with a thumbnail 56, reproduction 56, or other indicator of a potential obstacle 58 identified in the field imagery 50. In certain implementations, a user may then indicate if the obstacle 58 shown in the thumbnail 56 is a transient or static obstacle by pressing the corresponding buttons 60. In certain other implementations, the system 100 may pre-classify and object based on prior classification, object recognition, artificial intelligence, and/or machine learning and the user may modify or confirm the classification via the classification function 54.

Although the disclosure has been described with references to various embodiments, persons skilled in the art will recognized that changes may be made in form and detail without departing from the spirit and scope of this disclosure.

What is claimed is:

1. An aerial guidance system, comprising:
a. an imaging device constructed and arranged to generate aerial images of a field; and
b. a processor in operative communication with the imaging device,
wherein the processor is configured to:
i. process the aerial images, and
ii. generate guidance paths for traversal by agricultural implements.

2. The aerial guidance system of claim 1, further comprising a central storage device in operative communication with the processor.

3. The aerial guidance system of claim 1, wherein the imaging device is a satellite.

4. The aerial guidance system of claim 1, wherein the imaging device is a drone.

5. The aerial guidance system of claim 1, further comprising a monitor in operative communication with the processor and configured to display the aerial images to a user.

6. A method of generating guidance paths for agricultural processes, comprising:
acquiring overhead images via an imaging device;
identifying crop rows in the acquired aerial images; and
generating one or more guidance paths for traversal by an agricultural implement.

7. The method of claim 6, further comprising displaying the guidance paths on a monitor.

8. The method of claim 6, further comprising adjusting manually the guidance paths by a user.

9. The method of claim 6, further comprising determining an actual location of one or more geo-referenced ground control points and adjusting the one or more guidance paths based on the actual location of one or more geo-referenced ground control points in the aerial images.

10. The method of claim 6, wherein the imaging device is a terrestrial vehicle, manned aerial vehicle, satellite, or unmanned aerial vehicle.

11. The method of claim 10, wherein the imaging device is an unmanned aerial vehicle.

12. The method of claim 6, further comprising displaying the one or more guidance paths on a display or monitor.

13. The method of claim 6, further comprising providing a software platform for viewing the one or more guidance paths.

14. A method for providing navigation guidance paths for agricultural operations comprising:
obtaining aerial images of an area of interest;
processing the aerial images to determine actual locations of one or more crop rows; and
generating guidance paths based on actual locations of the one or more crop rows.

15. The method of claim 14, further comprising performing distortion correction on the aerial images.

16. The method of claim 14, further comprising identifying actual locations of one or more geo-referenced ground control points found in the aerial images.

17. The method of claim 16, wherein the one or more geo-referenced ground control points comprise at least one of a terrain feature, a road intersection, or a building.

18. The method of claim 14, wherein the aerial images are obtained in an early stage of a growing season.

19. The method of claim 14, further comprising inputting terrain slope data to determine actual crop row locations and spacing.

20. The method of claim 14, further comprising performing resolution optimization on the aerial images.
